(19) United States
(12) Patent Application Publication
(10) Pub. No.: US 2020/0294782 A1
(43) Pub. Date: Sep. 17, 2020

(54) REACTION GAS SUPPLY EQUIPMENT OF AN INDUCTIVE COUPLED PLASMA MASS SPECTROMETER COMPRISES AN AMMONIA SUPPLY END AND A HELIUM SUPPLY END AND A REACTION GAS SUPPLY EQUIPMENT

(71) Applicant: Enrichflow Group Co., Ltd., Taichung City (TW)

(72) Inventor: Wei Fan Chen, Taichung City (TW)

(21) Appl. No.: 16/587,201

(22) Filed: Sep. 30, 2019

(30) Foreign Application Priority Data
Mar. 13, 2019 (TW) 108108479

(51) Int. Cl. H01J 49/10; H01J 49/26; H05H 1/46; H05H 1/30; G01N 21/73

(52) U.S. Cl. CPC H01J 49/105; H01J 49/26; H05H 2001/4652; H05H 1/30; G01N 21/73; H05H 1/46

(57) ABSTRACT

A reaction gas supply equipment of an inductive coupled plasma mass spectrometer comprises an ammonia supply end and a helium supply end and a reaction gas supply equipment, which is supplied with an ammonia supply end and a helium supply end, and the reaction gas supply equipment is provided with an ammonia mass flow meter to adjust the flow of ammonia and helium mass flow meter to adjust the flow of helium; the ammonia mass flow meter and helium mass flow meter are adjusted by the proportion of reaction gas specified by the inductive coupled plasma spectrometer, and ammonia gas is mixed with helium gas to form reaction gas, which is then provided to the inductive coupled plasma mass spectrometer; through the technical means of the prevent invention, several advantages such as the protection of detection instrument and the reduction of cost of reaction gas can be achieved.

### TECHNICAL FIELD

This invention relates to a reaction gas supply module of a detection equipment, and it specifically relates to a reaction gas supply equipment and its preparation method for an inductive coupled plasma mass spectrometer; through the reaction gas supply equipment provided by this invention and the reaction gas preparation method, test unit can use correct reaction gas to conduct elemental test, therefore, element detection rate can be enhanced, and inductive coupled plasma mass spectrometer can be protected.

### BACKGROUND

Inductive coupled plasma mass spectrometer is used to conduct measurement and analysis, and the analysis technique can measure quantitatively the elemental content of a material with measurement ranges from ppt to wt %/o. It is applicable only to C, H and 0, and it is not applicable to N and halogen.

Its application way is to spray the sample solution into the core of inductive coupled plasma, and the plasma temperature is as high as 8000° C., therefore, under such high temperature, all the species under analysis will be atomized, ionized and thermally excited, then the material to be tested can be detected and measured.

Wherein inductive coupled plasma mass spectrometer is mainly used to measure the mass of elemental ion generated by high temperature Ar ion; the ions generated in the plasma are then separated according to their charge to mass ratios, therefore, the unknown material can be identified and quantified.

Therefore, when industries such as aerospace industry, sputtering target, chemical, alloy manufacturer, food/beverage, geology, pharmaceutical, environmental water, waste water and treated water need to propose related report such as certification of material, they will usually consign test department to use inductive coupled plasma mass spectrometer to conduct related data analysis such as elemental content and concentration, etc.

Wherein Agilent 8900 series inductive coupled plasma mass spectrometers manufactured by Agilent Technologies Inc. are frequently used by large domestic test departments or semiconductor high tech companies. During semiconductor manufacturing process, in order to test specific element, it is needed to use inductive coupled plasma mass spectrometer to test elements contained in a wafer; and the reaction gas spec provided by that company is about 10% NH₃ (ammonia) and 90% He (helium), however, the inventor of the present invention has found that most major domestic suppliers purchase ammonia steel bottles from the gas company, and 100% NH₃ (ammonia) is used to conduct elemental test, therefore, the following problems are caused:

1. Because the corrosive characteristic of NH₃ (ammonia) is destructive to inductive coupled plasma mass spectrometer, many major domestic test departments have their mass spectrometers sent for repairing, it not only delays the test schedule, the supplier of inductive coupled plasma mass spectrometer is also frequently annoyed by such troubles.

2. The inventor finds that the above mentioned problem was because that the test personnel of domestic test departments, due to their incapability of adjusting the reaction gas proportion themselves, have to use directly ammonia as reaction gas for the test.

3. In addition, because the quantity of the above mentioned reaction gas (ammonia) used was not large, the test department, in order to save cost, has to use directly ammonia, which leads indirectly the damage of the test instrument.

4. High maintenance cost of inductive coupled plasma mass spectrometer has led to the great increase of cost of the test department.

5. Because ammonia is reaction gas, if pure ammonia is used as reaction gas, it might lead to pipeline breaking and the suspicion of ammonia leak, meanwhile, ammonia is harmful to human body, therefore, it could easily lead to industrial safety issue.

Therefore, how to solve the problems and drawbacks of the prior art have become topics of great concerns of the related suppliers.

### SUMMARY OF THE INVENTION

The main objective of the present invention is to provide reaction gas supply equipment and preparation method for inductive coupled plasma mass spectrometer. In this invention, reaction gas supply equipment is mainly connected to ammonia gas supply end and a helium gas supply end, then two reaction gases are mixed in mixing pipeline, then the pressure of the pipeline was controlled to fully mix the gases, then the reaction gases were sent to inductive coupled plasma mass spectrometer for test, through the technical means of this invention, advantages such as the protection of test instrument and the reduction of the cost of reaction gas can be achieved.

Therefore, the reaction gas supply equipment of inductive coupled plasma mass spectrometer of the present invention is achieved through the following technical means: an ammonia supply end which can supply ammonia; a helium supply end, which supply helium; having the following features: a reaction gas supply equipment, which is connected respectively to the ammonia supply end and the helium supply end, meanwhile, the reaction gas supply equipment is installed with an output end, which is connected to the inductive coupled plasma mass spectrometer, and the reaction gas supply equipment contains an ammonia pipeline and a helium pipeline; the previously mentioned ammonia pipeline further comprises a first ammonia pressure regulating valve, an ammonia mass flow meter and a second ammonia pressure regulating valve; the previously mentioned helium pipeline further comprises a first helium pressure regulating valve, a helium mass flow meter and a second helium pressure regulating valve; and the ammonia pipeline, relative to one side of the ammonia supply end, and the helium pipeline, relative to one side of the helium supply end, is pulled upwards with a mixing pipeline, and the mixing pipeline is connected to the ammonia pipeline and the helium pipeline; moreover, the mixing pipeline is connected to the output end to supply the reaction gas to the inductive coupled plasma mass spectrometer.

Through the above mentioned equipment, the preparation method of reaction gas of the present invention is; step 1: open the above mentioned ammonia supply end and helium supply end so that ammonia and helium can flow into the ammonia pipeline and the helium pipeline; step 2: adjust the previously mentioned first ammonia pressure regulating valve, the second ammonia pressure regulating valve, the first helium pressure regulating valve and the second helium pressure regulating valve to 10˜20 psi, and the inner pipe pressure of mixing pipeline connected under such state will be remained at 10˜20 psi; step 3: adjust the supply parameter of the previously mentioned ammonia mass flow meter as 0.1 L/min, and the supply parameter of helium mass flow meter as 0.9 L/min; through this, ammonia and helium, through the pressure state of 10˜20 psi, are fully mixed to form reaction gas to be used by the inductive coupled plasma mass spectrometer.

In one embodiment of reaction gas supply equipment of the present invention, in between the above mentioned ammonia pipeline and the above mentioned mixing pipeline, and in between the above mentioned helium pipeline and the above mentioned mixing pipeline, it is installed respectively with a check valve to prevent the back flow of the gas.

In one embodiment of reaction gas supply equipment of the prevent invention, if ammonia is permeated with moisture, it will become NH₄OH, which is a strong alkaline and its physical and chemical property will be hazardous to human body and the pipeline, therefore, for the present invention, the ammonia pipeline, the mixing pipeline and the output end are connected and installed with a heating module for heating, for the above mentioned heating module, pipeline is winded with multiple metal heating belts, meanwhile, the heating module raised those metal heating belts to 70˜80° C. to prevent the mixing of moisture into the pipeline to form NH₄OH.

In one embodiment of reaction gas supply equipment of the present invention, the mixing pipeline is further connected to a gas storage unit, through the gas storage unit, massive reaction gases can be stored, therefore, when massive reaction gases are needed, the gas storage unit can supply reaction gas to increase test convenience.

Through the equipment and technical means of the present invention, the followings can be realized: 1. This invention can indeed provide correct gas proportion for the test of inductive coupled plasma mass spectrometer; therefore, the test department does not need to order specific reaction gas from the gas supplier, and the test cost of the test department can be reduced; 2. This can prevent the problem of using pure ammonia as reaction gas to lead to the damage of inductive coupled plasma mass spectrometer.

A detailed description is given in the following embodiments with reference to the accompanying drawings.

### BRIEF DESCRIPTION OF THE DRAWINGS

The components, characteristics and advantages of the present invention may be understood by the detailed descriptions of the preferred embodiments outlined in the specification and the drawings attached. Embodiments of the invention are illustrated by way of example, and not by way of limitation, in the figures of the accompanying drawings in which like reference numerals refer to similar elements.

FIG. 1 Structural illustration of reaction gas supply equipment of the present invention.

FIG. 2 It is illustration of pipeline winded with metal heating belt.

FIG. 3 It is structural illustration of the present invention included with a gas storage unit.

FIG. 4 It is flow diagram of method of the present invention when applying in preparing reaction gas.

FIG. 5 It is structural illustration of another embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

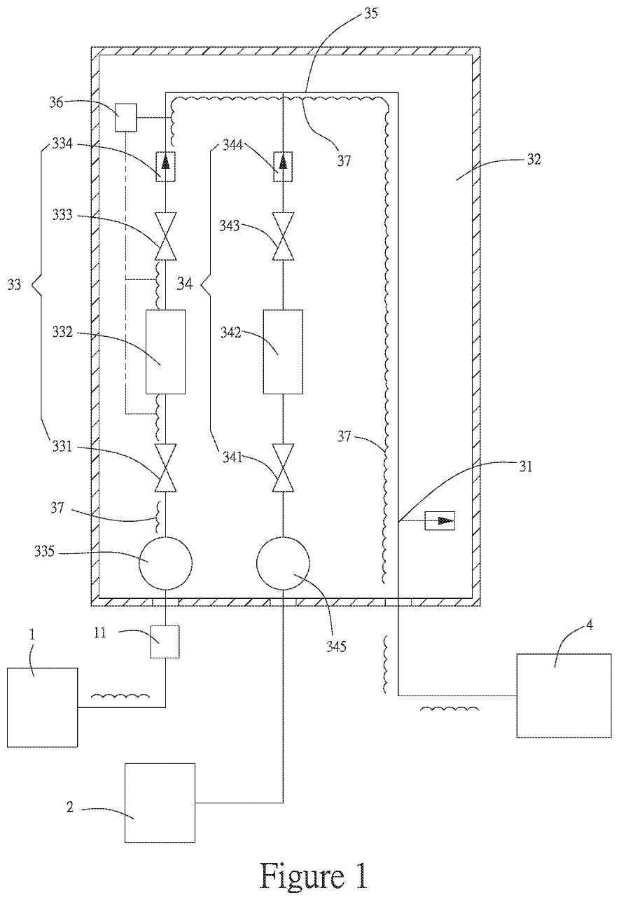

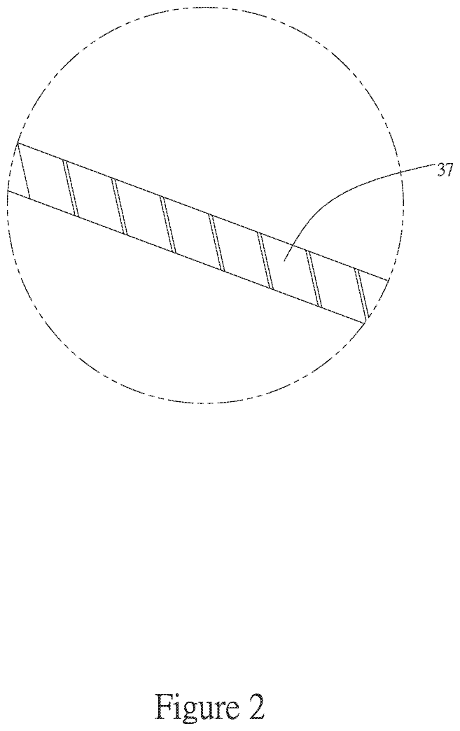

Please refer to FIG. 1 to FIG. 3, which show the reaction gas supply equipment of inductive coupled plasma mass spectrometer of the present invention, and it comprises of: an ammonia supply end 1, a helium supply end 2 and a reaction gas supply equipment 3.

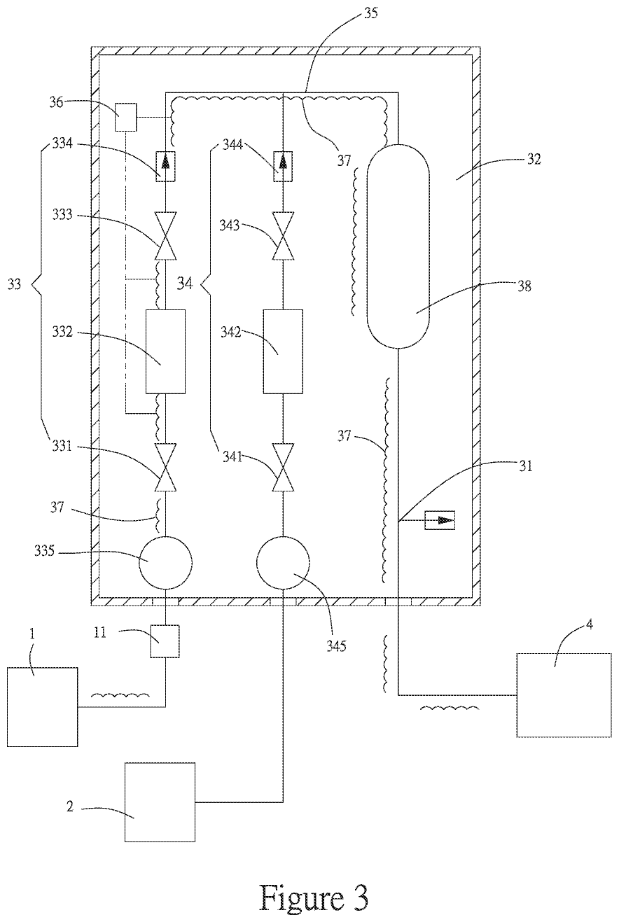

The above mentioned ammonia supply end 1 can provide ammonia, wherein the purity of ammonia should be as close to 100/o as possible to be able to generate better analysis data and to reduce the environmental impurity; as shown in FIGS. 1 and 3, the ammonia supply end 1 is installed with a purifier 11, which can filter out impurity within ammonia.

The above mentioned helium supply end 2 can provide helium, wherein the purity of helium should be as close to 100% as possible so that it can generate better analysis data and can reduce the environmental impurity.

The above mentioned reaction gas supply equipment 3 is connected respectively to the ammonia supply end 1 and the helium supply end 2, meanwhile, the reaction gas supply equipment 3 is installed with an output end 31 which is connected to the inductive coupled plasma mass spectrometer 4; as shown in FIGS. 1 and 3, the reaction gas supply equipment 3 is installed with a machine body 32, and the after-mentioned equipment are mostly installed within machine body 3, and the reaction gas supply equipment 3 includes an ammonia pipeline 33 and a helium pipeline 34; and above the previously mentioned ammonia pipeline 33, it includes in sequence a first ammonia pressure regulating valve 331, an ammonia mass flow meter 332 and a first and second ammonia pressure regulating valve 333; and the previously mentioned helium pipeline 34 comprises in sequence a first helium pressure regulating valve 341, a helium mass flow meter 34 and a first and second helium pressure regulating valve 343.

Please refer further to FIGS. 1 and 3, the ammonia pipeline 33, relative to one side of the ammonia supply end 1, and the helium pipeline 34, relative to one side of the helium supply end 2, are pulled upwards with a mixing pipeline 35, and the mixing pipeline 35 is connected to the ammonia pipeline 33 and the helium pipeline 34; the mixing pipeline 35 is connected to the output end 31 so that reaction gas can be supplied to the inductive coupled plasma mass spectrometer 4.

Furthermore, in between the previously mentioned ammonia pipeline 33 and previously mentioned mixing pipeline 35, and in between the helium pipeline 34 and the previously mentioned mixing pipeline 35, it is installed respectively with a check valve 334 to prevent the back flow of the gas, 344; furthermore, the ammonia pipeline 33, the mixing pipeline 35 and the output end 31 are connected and installed with a heating module 36 to heat, and for previously mentioned heating module 36, multiple metal heating belts 37 are winded on previously mentioned ammonia pipeline 33, mixing pipeline 35 and output end 31, meanwhile, the heating module 36 heat those metal heating belts 37 to temperature in the range of 70˜80° C. to prevent the pipeline from mixing with moisture to form NH₄OH.

Through the above mentioned equipment, the test department can purchase from gas supplier ammonia steel cylinder and helium cylinder as ammonia supply end 1 and helium supply end 2 of the present invention; then connect ammonia pipeline 33 and ammonia supply end 1, and connect helium pipeline 34 and helium supply end 2, then you can mix through previously mentioned reaction gas supply equipment 3 to form and supply reaction gas for the inductive coupled plasma mass spectrometer 4.

As shown in FIG. 3, its structure is basically the same as that of FIG. 1, and the difference is: Mixing pipeline 35 is further connected a gas storage unit 38, and through the gas storage unit 38, massive reaction gases can be stored, therefore, when massive reaction gases are needed, the gas storage unit 38 can supply reaction gases to increase the test convenience.

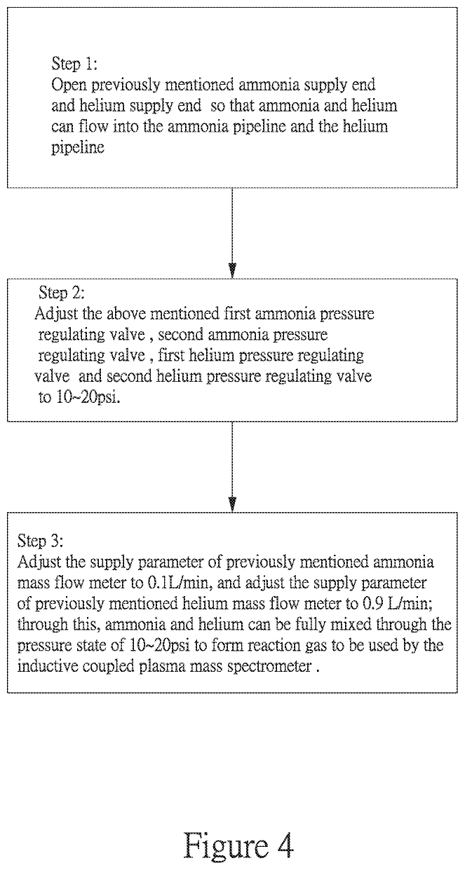

As shown in FIG. 4, through the above mentioned equipment, this invention further comprises of preparation method for reaction gas as follows:

Step 1: Open previously mentioned ammonia supply end 1 and helium supply end 2 so that ammonia and helium can flow into the ammonia pipeline 33 and the helium pipeline 34.

Step 2: Adjust the above mentioned first ammonia pressure regulating valve 331, second ammonia pressure regulating valve 333, first helium pressure regulating valve 341 and second helium pressure regulating valve 343 to 10˜20 psi, under such state, the inner pipe pressure of connected mixing pipeline 35 will be remained at 10˜20 psi; wherein, to facilitate the operation personnel to adjust the pressure, in between the ammonia supply end 1 and the ammonia pipeline 33, it is installed with an ammonia pressure gauge 335, and in between the helium supply end 2 and the helium supply pipeline 34, it is installed with a helium pressure gauge 345, through the ammonia pressure gauge 335 and the helium pressure gauge 345, the ammonia pipeline 33 and the helium pipeline 34 can be adjusted quickly to 10˜20 psi.

Step 3: Adjust the supply parameter of previously mentioned ammonia mass flow meter 332 to 0.1 L/min, and adjust the supply parameter of previously mentioned helium mass flow meter 342 to 0.9 L/min; through this, ammonia and helium can be fully mixed through the pressure state of 10˜20 psi to form reaction gas to be used by the inductive coupled plasma mass spectrometer 4.

Therefore, preparation method of reaction in the present invention can let reaction gas meet exactly the correct proportion of reaction gas for test conducted by inductive coupled plasma mass spectrometer 4. Reaction gas provided by the present invention can reduce the quantity of usage of ammonia, in addition, it will be difficult to lead to the corrosion and damage issues of inductive coupled plasma mass spectrometer 4, meanwhile, it can also reduce the impurity from the environment so that the object under test can be easily judged for its element, element content or even element concentration.

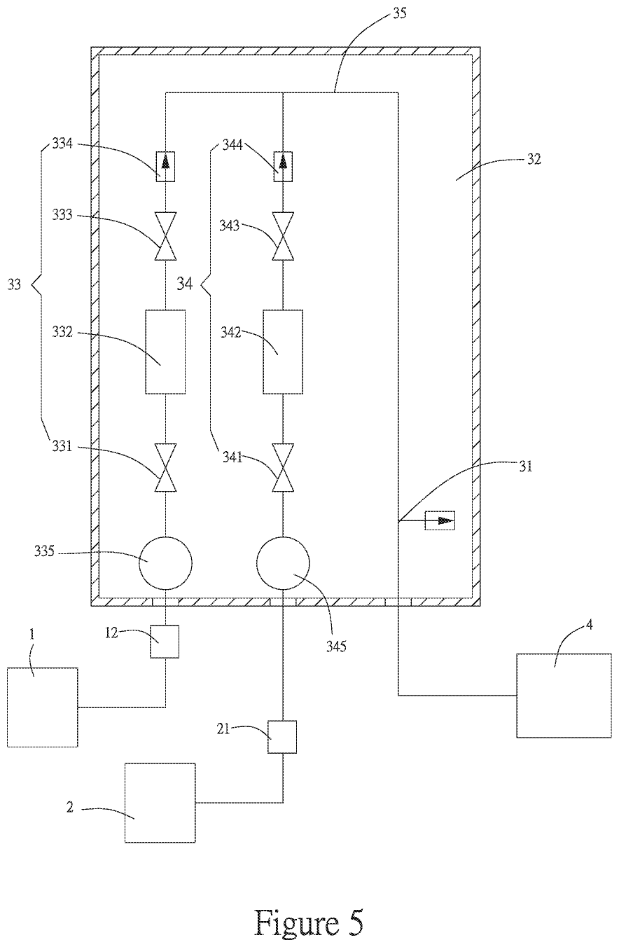

As shown in FIG. 5, it is the second embodiment of reaction gas supply equipment 3 of the present invention, in this embodiment, its main feature is that a water filter is installed on ammonia supply end 1 and helium supply end 2 to prevent the freezing caused by moisture in previously mentioned ammonia pipeline 33 or helium pipeline 34, in other words, for previously mentioned ammonia pipeline 33 or helium pipeline 34, it is not needed to install additional heating module 36 and metal heating belt 37, and the specific embodiment method of the present embodiment is: Install an ammonia supply end 1 and a helium supply end 2, and have previously mentioned ammonia supply end 1 and previously mentioned helium supply end 2 connected to a reaction gas supply equipment 3, wherein, the ammonia supply end 1 is installed with a water filter 12, and the helium supply end is also installed with a water filter 21, and the above mentioned water filters 12 and 21 are used to filter out moisture in ammonia and helium to prevent the freezing of the pipeline; the reaction gas supply equipment 3 basically has the same structure as mentioned in FIG. 1 to 3, and it comprises of an ammonia pipeline 33 and a helium pipeline 34, and the ammonia pipeline 33 comprises in sequence a first ammonia pressure regulating valve 331, an ammonia mass flow meter 332 and a second ammonia pressure regulating valve 333; previously mentioned helium pipeline 34 comprises in sequence a first helium pressure regulating valve 341, a helium mass flow meter 342 and a second helium pressure regulating valve 343; and the ammonia pipeline 33, relative to one side of the ammonia supply end 1, and the helium pipeline 34, relative to one side of the helium supply end 2, are pulled upwards with a mixing pipeline 35, and the mixing pipeline 35 is connected to the ammonia pipeline 33 and the helium pipeline 34; and the mixing pipeline 35 is connected to the output end 31 to supply reaction gas to the inductive coupled plasma mass spectrometer 4. Since the principle of this embodied method is the same as that in FIG. 1 to 3, therefore, it will not be repeatedly stated here.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. An reaction gas supply equipment for inductive coupled plasma mass spectrometer, comprising of:
an ammonia supply end which can supply ammonia; a helium supply end, which can supply helium; having the following features:
a reaction gas supply equipment, which is connected respectively to the ammonia supply end and the helium supply end, meanwhile, the reaction gas supply equipment is installed with an output end to be connected to an inductive coupled plasma mass spectrometer, and the reaction gas supply equipment comprises of an ammonia pipeline and a helium pipeline;
previously mentioned ammonia pipeline further comprises of a first ammonia pressure regulating valve, an ammonia mass flow meter and a second ammonia pressure regulating valve;
previously mentioned helium pipeline further comprises of a first helium pressure regulating valve, a helium mass flow meter and a second helium pressure regulating valve; the ammonia pipeline, relative to one side of the ammonia supply end, and the helium pipeline, relative to one side of the helium supply end, are pulled upwards with a mixing pipeline, and the mixing pipeline is connected with the ammonia pipeline and the helium pipeline;
the mixing pipeline is connected to the output end to supply reaction gas to the inductive coupled plasma mass spectrometer.

2. The preparation method for reaction gas generated by reaction gas supply equipment of inductive coupled plasma mass spectrometer as mentioned in claim 1 is:
Step 1: Open previously mentioned ammonia supply end and helium supply end so that ammonia and helium can flow into the ammonia pipeline and the helium pipeline;
Step 2: Adjust the previously mentioned first ammonia pressure regulating valve, second ammonia pressure regulating valve, first helium pressure regulating valve and second helium pressure regulating valve to 10˜20 psi, under such state, inner pipe pressure of connected mixing pipeline will be remained at 10˜20 psi too;
Step 3: Adjust the supply parameter of previously mentioned ammonia mass flow meter to 0.1 L/min, and adjust the supply parameter of helium mass flow meter to 0.9 L/min; through this, ammonia and helium can have full mixing under the pressure state of 10˜20 psi to form reaction gas to be used by the inductive coupled plasma mass spectrometer.

3. The reaction gas supply equipment of inductive coupled plasma mass spectrometer of claim 1, wherein in between previously mentioned ammonia pipeline and previously mentioned mixing pipeline, and in between previously mentioned helium pipeline and previously mentioned mixing pipeline, it is installed further with a check valve to prevent the back flow of gas.

4. The reaction gas supply equipment of inductive coupled plasma mass spectrometer of claim 1, wherein the ammonia pipeline, the mixing pipeline and the output end are connected and installed with a heating module for heating, and previously mentioned heating module is winded with multiple metal heating belts on the pipeline.

5. The reaction gas supply equipment of inductive coupled plasma mass spectrometer of claim 4 wherein the heating module heats those metal heating belts to 70˜80° C. to prevent the mixing of moisture into the pipeline to form NH₄OH.

6. The reaction gas supply equipment of inductive coupled plasma mass spectrometer of claim 1, wherein the mixing pipeline is further connected to a gas storage unit.

7. The reaction gas supply equipment of inductive coupled plasma mass spectrometer of claim 1, wherein in between the ammonia supply end and the ammonia pipeline, it is installed with an ammonia pressure gauge, and in between the helium supply end and the helium supply pipeline, it is installed with a helium pressure gauge, through the ammonia pressure gauge and the helium pressure gauge, the pipeline pressures of the ammonia pipeline and the helium pipeline are quickly adjusted.

8. A reaction gas supply equipment of an inductive coupled plasma mass spectrometer, comprising of:
an ammonia supply end which can supply ammonia, and the ammonia supply end is installed with a water filter; a helium supply end, which can supply helium, and the helium supply end is similarly installed with a water filter;
having the following features:
previously mentioned ammonia pipeline further comprises of a first ammonia pressure regulating valve, an ammonia mass flow meter and a second ammonia pressure regulating valve;
previously mentioned helium pipeline further comprises of a first helium pressure regulating valve, a helium mass flow meter and a second helium pressure regulating valve; the ammonia pipeline, relative to one side of the ammonia supply end, and the helium pipeline, relative to one side of the helium supply end, are pulled upwards with a mixing pipeline, and the mixing pipeline is connected to the ammonia pipeline and the helium pipeline;
the mixing pipeline is connected to the output end to supply reaction gas to an inductive coupled plasma mass spectrometer.
